(19) United States
(12) Patent Application Publication
(10) Pub. No.: US 2012/0250146 A1
(43) Pub. Date: Oct. 4, 2012

(54) LAMINATED GLASS

(75) Inventors: Kazuhiro Tamai, Tokyo (JP); Yuichi Hino, Tokyo (JP); Tamotsu Morimoto, Tokyo (JP); Takeomi Miyako, Tokyo (JP); Koji Sasaki, Tokyo (JP)

(73) Assignee: ASAHI GLASS COMPANY, LIMITED, Tokyo (JP)

(21) Appl. No.: 13/526,176

(22) Filed: Jun. 18, 2012

Related U.S. Application Data
(63) Continuation of application No. PCT/JP2010/071615, filed on Dec. 2, 2010.

(30) Foreign Application Priority Data
Dec. 16, 2009 (JP) 2009-285548

(51) Int. Cl. G02B 5/22; B82Y 20/00

(52) U.S. Cl. 359/361; 977/902

(57) ABSTRACT

The present invention relates to a laminated glass including: a pair of glass substrates facing with each other; a composite film arranged between the pair of glass substrates and including a resin film and an infrared reflective film which includes a high refractive index layer and a low refractive index layer and is formed on a light-incident-side main surface of the resin film; and a pair of adhesive sheets arranged between the pair of glass substrates and the composite film to bond the pair of glass substrates and the composite film, in which the laminated glass has the specific configuration.

### TECHNICAL FIELD

The present invention relates to a laminated glass, and particularly relates to a laminated glass having low total solar transmittance.

### BACKGROUND ART

A laminated glass in which an infrared reflective film which blocks transmission of infrared rays (heat rays) in the sunlight is provided between a pair of glass substrates facing with each other, thereby reducing rise in temperature in a room and cooling load has conventionally been known as a laminated glass used in a windshield of vehicles and the like. For example, as an infrared reflective film, one obtained by alternately laminating an oxide layer and a metal layer that constitute an infrared reflective film on a resin film that constitutes a base material, and one obtained by alternately laminating a high refractive index layer and a low refractive index layer that constitute an infrared reflecting film on a resin layer, are known, and the these films are adhered between a pair of glass substrates by a pair of adhesive sheets (for example, see Patent Document 1).

Furthermore, as a laminated glass, one comprising a pair of glass substrates adhered with an adhesive sheet containing infrared shielding fine particles is known. For example, indium oxide fine particles doped with tin (ITO fine particles) are known as preferable infrared shielding fine particles (for example, see Patent Document 2).

### BACKGROUNG ART DOCUMENTS

### Patent Document

Patent Document 1: JP-A 2009-35438

Patent Document 2: JP-A 2003-261361

### SUMMARY OF THE INVENTION

### Problems that the Invention is to Solve

In recent years, a heat shielding glass is employed as a glass for vehicles for the purpose of shielding solar radiation energy flown in the vehicles through a glass for vehicles and reducing temperature rise and cooling load in vehicles. Furthermore, in particular it is preferred for a glass for vehicles to have excellent permeability of various radio waves and relatively high visible light transmittance in addition to high heat shielding performance.

Of the infrared reflective films described above, the film comprising an oxide layer and a metal layer that are alternately laminated has high reflectivity, but is radio wave-impermeable. Therefore, there is a possibility that devices utilizing radio waves, such as garage openers, mobile phones and the like, cannot send and receive radio waves in the vehicles. On the other hand, an infrared reflective film comprising a high reflective layer and a low reflective layer that are alternately laminated does not have a metal film. Therefore, the film has good radio wave permeability, but heat-shielding performance is not always sufficient.

For example, CARB (regulation by California Air Resources Board starting in 2012) will require that the total solar transmittance defined by ISO 13837 (2008) must be 50% or less. However, the above method is difficult to achieve the total solar transmittance (Tts) of 50%, and it will be difficult to adapt the total solar transmittance to the regulation.

The present invention has been made to solve the above problems, and has an object to provide a laminated glass having low total solar transmittance.

### Means for Solving the Problems

The laminated glass of the present invention comprises a pair of glass substrates facing with each other, a composite film arranged between the pair of glass substrates and comprising a resin film and an infrared reflective film which comprises a high refractive index layer and a low refractive index layer and is formed on a light-incident-side main surface of the resin film, and a pair of adhesive sheets arranged between the pair of glass substrates and the composite film to bond the pair of glass substrates and the composite film, wherein the laminated glass has at least one of the following configurations (1) to (3):

(1) the composite film has a near infrared absorbing film comprising a transparent resin having a near infrared absorbing dye dispersed therein, on a light exit side main surface of the resin film;

(2) of the pair of adhesive sheets, the adhesive sheet on the light exit side with respect to the composite film contains infrared shielding fine particles; and

(3) of the pair of glass substrates, the glass substrate on the light exit side with respect to the composite film is a UV green glass plate.

The near infrared absorbing film is preferably a film that uses a diimmonium dye as the near infrared absorbing dye, and is preferably a coating film obtained by, for example, coating a coating liquid comprising the transparent resin, the near infrared absorbing dye and a solvent on the resin film, followed by drying. On the other hand, the infrared shielding fine particles contained in the adhesive sheets are preferably, for example, indium oxide fine particles doped with tin.

### Advantage of the Invention

According to the present invention, in a laminated glass in which a composite film having an infrared reflective film comprising a high refractive index layer and a low refractive index layer, formed on a light-incident-side main surface of a resin film, is bonded between a pair of glass substrates by a pair of adhesive sheets, (1) the composite film has a near infrared absorbing film comprising a transparent resin having near infrared absorbing dye dispersed therein, on a light exit side main surface of the resin film, (2) of the pair of the adhesive sheets, the adhesive sheet on the light exit side with respect to the composite film contains infrared shielding fine particles, or (3) of the pair of glass substrates, the glass substrate on the light exit side with respect to the composite film is a UV green glass plate, whereby the total solar transmittance can be reduced as compared with the conventional laminated glass.

### BRIEF DESCRIPTION OF THE DRAWINGS

FIG. 1 is a cross-sectional view showing a basic configuration of the laminated glass of the present invention.

FIG. 2 is a cross-sectional view showing one example of the laminated glass of the present invention, having a near infrared absorbing film.

### MODE FOR CARRYING OUT THE INVENTION

The laminated glass of the present invention is described below.

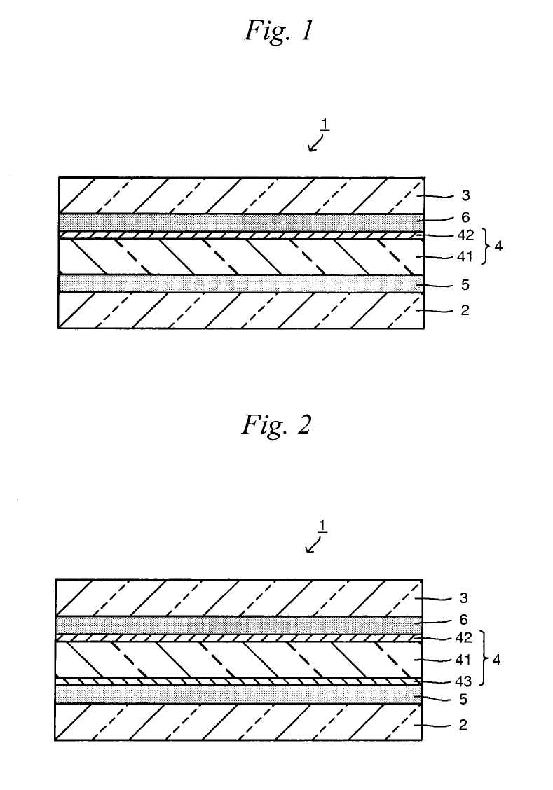

FIG. 1 is a cross-sectional view showing a basic configuration of the laminated glass 1 of the present invention.

A laminated glass 1 of the present invention has a basic configuration that a composite film 4 comprising a resin film 41 and an infrared reflective film 42 comprising a high refractive index layer and a low refractive index layer, formed on a light-incident-side main surface of the resin film 41 is adhered between a pair of glass substrates 2 and 3 facing with each other by adhesive layers 5 and 6, and is integrated.

The laminated glass 1 shown in FIG. 1 is shown such that the upper side in FIG. 1 is a light incident side that light such as sunlight enters, that is, the outside in the case of using in vehicles and the like, and the lower side in FIG. 1 is a light exit side, that is, the inside in the case of using in vehicles and the like. As shown in FIG. 1, the infrared reflective film 42 is preferably formed at the outside of vehicles.

The laminated glass 1 of the present invention has at least one of the following configurations (1) to (3), in addition to the above basic configuration.

(1) The composite film 4 has a near infrared absorbing film 43 (FIG. 2) comprising a transparent resin having near infrared absorbing dye dispersed therein, on a light exit side main surface of the resin film 41.

(2) Of the pair of the adhesive sheets 5 and 6, the adhesive sheet 5 on the light exit side with respect to the composite film 4 contains infrared shielding fine particles.

(3) Of the pair of the glass substrates 2 and 3, the glass substrate 2 on a light exit side with respect to the composite film 4 is a UV green glass plate.

The infrared reflective film is a film having properties of selectively reflecting light in an infrared region (wavelength region: 780 nm to 10,000 nm) utilizing interference of light of a thin film. The near infrared absorbing film is a film selectively absorbing light in a near infrared region (wavelength region: 780 nm to 3,000 nm).

According to the laminated glass 1 of the present invention, the composite film 4 comprising the resin film 41 and the infrared reflective film 42 comprising a high refractive index layer and a low refractive index layer, formed on a light-incident-side main surface of the resin film 41 is used, and in addition to this, the laminated glass 1 has at least one configuration of the configurations (1) to (3). By this, light that cannot always sufficiently be reflected by only the infrared reflective film 42 can be absorbed in the near infrared absorbing film 43, the adhesive sheet 5 containing infrared shielding fine particles, or the glass substrate 2 comprising a UV green glass plate. As a result, the laminated glass can reduce total solar transmittance as compared with the conventional laminated glass.

Furthermore, for example, in the case using an organic dye as the near infrared absorbing dye in the near infrared absorbing film 43, the near infrared absorbing film 43 easily deteriorates by ultraviolet rays in sunlight. However, when the near infrared absorbing film 43 is arranged at a light exit side, that is, in the rear of the infrared reflective film 42, ultraviolet rays can previously be reduced to a certain extent by the infrared reflective film 42, and this can reduce ultraviolet rays entering the near infrared absorbing film 43, whereby the near infrared absorbing film 43 can be suppressed from deteriorating.

The composite film 4 has the infrared reflective film 42 on the light-incident-side main surface of the resin film 41, and according to the configuration of the laminated glass 1, the near infrared absorbing film 43 is provided on the light exit side main surface of the resin film 41. For example, a layer having other function, such as a protective layer, may be formed on the surfaces of the infrared reflective film 42 and the near infrared absorbing film 43, specifically on the surfaces contacting the adhesive sheets 5, 6.

The resin film 41 in the composite film 4 is not particularly limited so long as it comprises a transparent material, and can comprise polycarbonate, polymethyl methacrylate (PMMA), polyethylene terephthalate (PET), polyethylene naphthalate, polyimide, polyether sulfone, polyarylate, nylon, cycloolefin polymer or the like.

In general, polyethylene terephthalate (PET) is preferably used for the reasons that it has relatively high strength and it easily suppresses damage in producing the laminated glass 1. The thickness of the resin film 41 is not always limited, but is preferably 5 μm or more and 200 μm or less, more preferably 20 μm or more and 100 μm or less, and further preferably 20 μm or more and 50 μm or less.

The infrared reflective film 42 provided on the light-incident-side main surface of the resin film 41 can basically be the same as the infrared reflective film in the conventional laminated glass and can comprise a high refractive index layer and a low refractive index layer that are laminated alternately. The number of total layers of the high refractive index layer and the low refractive index layer is preferably 3 or more, the thickness of the high refractive index layer is preferably 70 nm or more and 150 nm or less, and the thickness of the low refractive index layer is preferably 100 nm or more and 200 nm or less.

The high refractive index layer has a refractive index of preferably 1.9 or more, and further preferably 1.9 or more and 2.5 or less, and specifically can comprise at least one selected from high refractive index materials such as tantalum oxide, titanium oxide, zirconium oxide and hafnium oxide.

The low refractive index layer has a refractive index of preferably 1.5 or less, and further preferably 1.2 or more and 1.5 or less, and specifically can comprise at least one selected from low refractive index materials such as silicon oxide and magnesium fluoride.

The infrared reflective film 42 can be formed on the resin film 41 by applying the conventional film-forming method, and can be formed by applying a magnetron sputtering method, an electron beam vacuum deposition method, a chemical vacuum deposition method or the like.

The near infrared absorbing film 43 provided on the light exit side main surface of the resin film 41 according to the configuration of the laminated glass 1 comprises a transparent resin and near infrared absorbing dye dispersed therein, and is a coating film obtained by, for example, dispersing the transparent resin and the near infrared absorbing dye in a solvent to prepare a coating liquid, coating the coating liquid on the resin film 41, followed by drying the resulting coating.

The thickness of the near infrared absorbing film 43 can appropriately be selected considering near infrared absorbing performance, productivity and the like. For example, the thickness is preferably 500 nm or more and 50 μm or less, more preferably 1 μm or more and 10 μm or less, and further preferably 2 μm or more and 6 μm or less. In the case where the thickness is less than 500 nm, sufficient near infrared absorbing performance cannot always be obtained. On the other hand, in the case where the thickness thereof exceeds 50 μm, a solvent may remain when forming the film.

From the standpoint of durability and the like, the transparent resin has a glass transition temperature of preferably 80° C. or higher and 180° C. or lower, and particularly preferably 120° C. or higher and 180° C. or lower. Examples of the transparent resin include thermoplastic resins such as a polyester resin, a polyacryl resin, a polyolefin resin, a polycycloolefin resin and a polycarbonate resin.

The transparent resin can use the commercially available products. For example, trade name: O-PET manufactured by Kanebo can be used as the polyester resin, trade name: HALS HYBRID IR-G204 manufactured by Nippon Shokubai Co., Ltd. can be used as the polyacryl resin, trade name: ARTON manufactured by JSR Corporation can be used as the polyolefin resin, trade name: ZEONEX manufactured by Zeon Corporation can be used as the polycycloolefin resin, and trade name: IUPILON manufactured by Mitsubishi Engineering-Plastics Corporation can be used as the polycarbonate resin.

The near infrared absorbing dye dispersed in the transparent resin can preferably use inorganic pigments, organic pigments, organic dyes and the like each having the maximum absorption wavelength in a range of from 800 to 1,100 nm. Those can be used alone or as mixtures of two or more thereof.

Examples of the inorganic pigments that can be used include cobalt dye, iron dye, chromium dye, titanium dye, vanadium dye, zirconium dye, molybdenum dye, ruthenium dye, platinum dye, ITO dye and ATO dye.

Examples of the organic pigments and organic dyes that can be used include diimmonium dye, anthraquinone dye, aminium dye, cyanine dye, merocyanine dye, croconium dye, squarylium dye, azulenium dye, polymethine dye, naphthoquinone dye, pyrylium dye, phthalocyanine dye, naphthalocyanine dye, naphtholactum dye, azo dye, condensed azo dye, indigo dye, perinone dye, perilene dye, dioxazine dye, quinacridone dye, isoindolinone dye, quinophthalone dye, pyrrole dye, thioindigo dye, metal complex dye, dithiol metal complex dye, indole phenol dye, and triallylmethane dye.

Of those near infrared absorbing dyes, organic pigments and organic dyes can preferably be used, and diimmonium dye that can efficiently absorb near infrared ray can particularly preferably be used.

The diimmonium dye is represented by the following general formula (1):

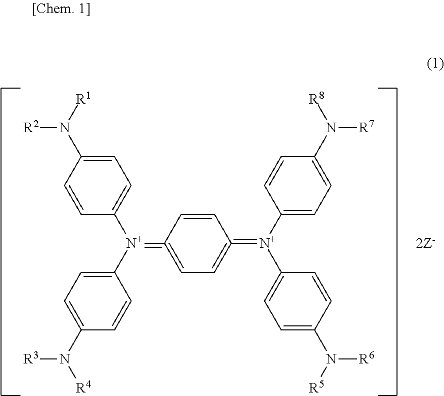

[In the formula, R¹ to R⁸ each independently represent hydrogen atom, an alkyl group, an alkyl group having a substituent, an alkenyl group, an alkenyl group having a substituent, an aryl group, an aryl group having a substituent, an alkynyl group or an alkylnyl group having a substituent, and Z⁻ represents an anion.]

Examples of the alkyl group include methyl group, ethyl group, n-propyl group, isopropyl group, n-butyl group, secondary butyl group, isobutyl group, tertiary butyl group, n-pentyl group, tertiary pentyl group, n-hexyl group, n-octyl group and tertiary octyl group, and a part thereof may be substituted with a substituent such as alkoxycarbonyl group, hydroxyl group, sulfo group or carboxyl group.

Examples of the alkenyl group include vinyl group, propenyl group, butenyl group, pentenyl group, hexenyl group, heptenyl group and octenyl group, and a part thereof may be substituted with a substituent such as hydroxyl group or carboxyl group.

Examples of the aryl group include benzyl group, p-chorobenzyl group, p-methylbenzyl group, 2-phenylmethyl group, 2-phenylpropyl group, 3-phenylpropyl group, α-naphthylmethyl group and β-naphthylethyl group, and a part thereof may be substituted with a substituent such as hydroxyl group or carboxyl group.

Examples of the alkynyl group include propynyl group, butynyl group, 2-chlorobutynyl group, pentynyl group and hexynyl group, and a part thereof may be substituted with a substituent such as hydroxyl group or carboxyl group.

Of those, n-butyl group or isobutyl group, particularly isobutyl group, is preferred. When R¹ to R⁸ each are n-butyl group or isobutyl group, durability to moisture is excellent.

Examples of Z⁻ include anions such as chlorine ion, bromine ion, iodine ion, perchlorate ion, periodate ion, nitrate ion, benzenesulfonate ion, p-toluenesulfonate ion, methylsulfate ion, ethylsulfate ion, propylsulfate ion, tetrafluoroborate ion, tetraphenylborate ion, hexafluorophosphate ion, benzenesulfinate ion, acetate ion, trifluoroacetate ion, propionacetate ion, benzoate ion, oxalate ion, succinate ion, malonate ion, oleate ion, stearate ion, citrate ion, monohydrogen diphosphate ion, dihydrogen monophosphate ion, pentachlorostannate ion, chlorosulfonate ion, fluorosulfonate ion, trifluoromethanesulfonate ion, hexafluoroarsenate ion, hexafluoroantimonate ion, molybdate ion, tangstate ion, titanate ion, ziconate ion, (R^{f}SO₂)₂N⁻ and (R^{f}SO₂)₃C⁻ (R^{f} represents C₁₋₄ fluoroalkyl group).

Of those anions, perchlorate ion, iodine ion, tetrafluoroborate ion, hexafluorophosphate ion, hexafluoroantimonate ion, trifluoromethanesulfonate ion, (R^{f}SO₂)₂N⁻ and (R^{f}SO₂)₃C⁻ are preferred, and (R^{f}SO₂)₂N⁻ and (R^{f}SO₂)₃C⁻ have excellent thermal stability and are particularly preferred.

Preferred examples of R^{f} in (R^{f}SO₂)₂N⁻ and (R^{f}SO₂)₃C⁻ include a perfluoroalkyl group such as —CF₃, —C₃F₇ or —C₄F₉; —C₂F₄H, —C₃F₆H and —C₄F₈H.

Of those diimmonium dyes, dyes having a molar absorption coefficient εₘ at near 1,000 nm of about 0.8×10⁴ or more and 1.0×10⁶ or less are preferred. The molar absorption coefficient εₘ can be obtained by the method shown below.

The diimmonium dye as a sample is diluted with chloroform such that a sample concentration is 20 mg/L, thereby preparing a sample solution. Absorption spectrum of the sample solution is measured with a spectrophotometer in a range of from 300 to 1,300 nm, and the maximum absorption wavelength (λₘₐₓ) is read. The molar absorption coefficient (εₘ) at the maximum absorption wavelength (λₘₐₓ) is calculated by the following formula.

ε=−log(I/I₀)

(ε: absorption coefficient, I₀: light intensity before incidence, I: light intensity after incidence)

εₘ=ε/(c·d)

(εₘ: absorption coefficient, c: sample concentration (mol/L), d: cell length)

The content of the near infrared absorbing dye is preferably 0.1 part by mass or more and 20 parts by mass or less, more preferably 0.1 part by mass or more and 10 parts by mass or less, and further preferably 0.5 part by mass or more and 4 parts by mass or less, based on 100 parts by mass of the transparent resin. In the case where the content of the near infrared absorbing dye is less than 0.1 part by mass, sufficient near infrared absorbing power may be not given to the near infrared absorbing film 43. On the other hand, in the case where the content thereof exceeds 20 parts by mass, durability of the near infrared absorbing film 43 may be decreased.

The diimmonium dye is preferably used as the near infrared absorbing dye. In the case of concurrently using the diimmonium dye and other near infrared absorbing dye, the content of the diimmonium dye is preferably 50% by mass or more based on the total amount of the diimmonium dye and the other near infrared absorbing dye. When the content of the diimmonium dye is 50% by mass or more, sufficient near infrared absorbing powder can be given to the near infrared absorbing film 43.

The transparent resin can contain at least one of various additives such as an adhesion modifier, a coupling agent, a surfactant, an antioxidant, a thermal stabilizer, a light stabilizer, an ultraviolet absorber, a fluorescent agent, a dehydrating agent, a defoaming agent, an antistatic agent and a flame retardant, according to the necessity.

The near infrared absorbing film 43 can be formed by dispersing the above-described transparent resin, near infrared absorbing dye, and according to the necessity, other components in a solvent to prepare a coating liquid, coating the coating liquid on the resin film 41, followed by drying.

An organic solvent can preferably be used as the solvent, and examples thereof include alcohols such as methanol, ethanol, isopropyl alcohol, deacetone alcohol, ethyl cellosolve and methyl cellosolve; ketones such as acetone, methyl ethyl ketone, cyclopentanone and cyclohexane; amides such as N,N-dimetnylformamide and N,N-dimethylacetamide; sulfoxides such as dimethylsulfoxide; ethers such as tetrahydrofuran, dioxane and ethylene glycol monomethyl ether; esters such as methyl acetate, ethyl acetate and butyl acetate; aliphatic halogenated hydrocarbons such as chloroform, methylene chloride, dichloroethylene, carbon tetrachloride and trichloroethylene; aromatics such as benzene, toluene, xylene, monochlorobenzene and dichlorobenzene; aliphatic hydrocarbons such as n-hexane and cyclohexanoligroin; and fluorine solvents such as tetrafluoropropyl alcohol and pentafluoropropyl alcohol.

The coating can be conducted by a dip coating method, a spray coating method, a spinner coating method, a bead coating method, a wire bar coating method, a blade coating method, a roller coating method, a curtain coating method, a slit dye coater method, a gravure coater method, a slit reverse coater method, a microgravure method or a comma coater method.

The adhesive sheets 5 and 6 are preferably sheets that can effectively bond the glass substrates 2 and 3 and the composite film 4, and can obtain sufficient visibility when the laminated glass 1 has been formed. For example, a thermoplastic resin composition comprising a thermoplastic resin as a main component can be formed to a sheet having a thickness of 0.1 mm or more and 1 mm or less, and preferably 0.2 mm or more and 0.5 mm or less. The adhesive sheets 5 and 6 can contain infrared shielding fine particles. For example, when the adhesive sheet 5 on the light exit side contains the infrared shielding fine particles, the total solar transmittance of the laminated glass 1 can effectively be reduced in conjunction with the composite film 4.

As the thermoplastic resin, thermoplastic resins conventionally used in the applications of this kind can be used, and examples thereof include a plasticized polyvinyl acetal resin, plasticized polyvinyl chloride resin, a saturated polyester resin, a plasticized saturated polyester resin, a polyurethane resin, a plasticized polyurethane resin, an ethylene-vinyl acetate copolymer resin and an ethylene-ethyl acrylate copolymer resin.

Of those, a plasticized polyvinyl acetal resin can preferably be used for the reason that balance of various properties such as transparency, weather resistance, strength, adhesive force, through-hole resistance, shock energy absorbability, moisture resistance, thermal insulating properties and sound insulating properties is excellent. Those thermoplastic resins can be used alone or as mixtures of two or more thereof. The term “plasticized” in the plasticized polyvinyl acetal resin means that the resin is being plasticized by the addition of a plasticizer. Other plasticized resins are the same as above.

The polyvinyl acetal resin is not particularly limited. A polyvinyl formal resin obtained by reacting polyvinyl alcohol (hereinafter referred to as “PVA” as necessary) and formaldehyde, a polyvinyl acetal resin in a narrow sense obtained by reacting PVA and acetaldehyde, a polybutyral resin (hereinafter referred to as “PVB” as necessary) obtained by reacting PVA and n-butyl aldehyde, and the like can be used. PVB can preferably be used for the reason that balance of various properties such as transparency, weather resistance, strength, adhesive force, through-hole resistance, shock energy absorbability, moisture resistance, thermal insulating properties and sound insulating properties is excellent. Those polyvinyl acetal resins may be used alone or as mixtures of two or more thereof.

The PVA used in the synthesis of the polyvinyl acetal resin is not particularly limited. However, the PVA having an average polymerization degree of 200 or more and 5,000 or less is preferred, and the PVA having an average polymerization degree of 500 or more and 3,000 or less is more preferred. The polyvinyl acetal resin is not particularly limited. However, the polyvinyl acetal resin having an acetalization degree of 40 mol % or more and 85 mol % or less is preferred, and the polyvinyl acetal resin having an acetalization degree of 50 mol % or more and 75 mol % or less is more preferred. The polyvinyl acetal resin having an amount of residual acetyl groups of 30 mol % or less is preferred, and the polyvinyl acetal resin having an amount of residual acetyl groups of 0.5 mol % or more and 24 mol % or less is more preferred.

The plasticizer is not particularly limited. For example, organic acid ester type plasticizers such as monobasic organic acid ester type and polybasic organic acid ester type, and phosphoric acid type plasticizers such as organophosphate type and organic phosphorous acid type can be used.

The amount of the plasticizer added varies depending on an average polymerization degree of the thermoplastic resin, an average polymerization degree, an acetalization degree and an amount of residual acetyl groups of the polyvinyl acetal resin, but is preferably 10 parts by mass or more and 80 parts by mass or less, based on 100 parts by mass of the thermoplastic resin. In the case where the amount of the plasticizer added is less than 10 parts by mass, plasticization of the thermoplastic resin is insufficient, and molding may become difficult. On the other hand, in the case where the amount of the plasticizer added exceeds 80 parts by mass, strength of the adhesive sheets 5 and 6 may be insufficient.

The adhesive sheet 5 on the light exit side preferably contains infrared shielding fine particles according to the configuration of the laminated glass 1. In particular, the embodiment that the adhesive sheet 5 comprises PVB and the infrared shielding fine particles are contained in the PVB is preferred. In the case of containing the infrared shielding fine particles, inorganic fine particles of metals such as Re, Hf, Nb, Sn, Ti, Si, Zn, Zr, Fe, Al, Cr, Co, Ce, In, Ni, Ag, Cu, Pt, Mn, Ta, W, V and Mo, its oxide, nitride, sulfide or silicon compound, or those doped with a dopant such as Sb, F or Sn can be used as the infrared shielding fine particles. Specifically, tin oxide fine particles doped with Sb (ATO fine particles), or indium oxide fine particles doped with Sn (ITO fine particles), particularly ITO fine particles, can preferably be used.

In the case of using the ITO fine particles, the ITO fine particles having an average particle size of primary particles of 100 nm or less are preferably used. In the case that an average particle size of the ITO fine particles exceeds 100 nm, transparency of the adhesive sheets 5 and 6 may be insufficient. The content of the ITO fine particles is preferably 0.1 parts by mass or more and 3.0 parts by mass or less, based on 100 parts by mass of the thermoplastic resin. In the case where the content of the ITO fine particles is less than 0.1 parts by mass, sufficient infrared shielding power cannot always be given. On the other hand, in the case where the content exceeds 3.0 parts by mass, visible light transmittance may be insufficient.

The thermoplastic resin composition can contain a thermoplastic resin and according to the necessity, infrared shielding fine particles, and can further contain at least one of various additives such as an adhesion modifier, a coupling agent, a surfactant, an antioxidant, a thermal stabilizer, a light stabilizer, an ultraviolet absorber, a fluorescent agent, a dehydrating agent, a defoaming agent, an antistatic agent and a flame retardant.

The glass substrates 2 and 3 each can use an inorganic transparent glass plate such as a clear glass plate, a green glass plate or a UV green glass plate, and an organic transparent glass plate such as a polycarbonate plate or a polymethyl methacrylate plate, except that the glass substrate 2 on the light exit side is a UV green glass plate according to the configuration of the laminated glass 1.

The glass substrates 2 and 3 can be different kinds from each other. For example, when the glass substrate 2 on the light exit side is a UV green glass plate, the total solar transmittance of the laminated glass 1 can be reduced in conjunction with the composite film 4. In particular, when the near infrared absorbing film 43 is provided on the composite film 4, the infrared shielding fine particles are contained in the adhesive sheet 5 on the light exit side, and additionally, the glass substrate 2 on the light exit side is a UV green glass plate, the total solar transmittance of the laminated glass 1 can further effectively be reduced.

The UV green glass plate means an ultraviolet absorbing green glass containing SiO₂ in an amount of 68% by mass or more and 74% by mass or less, Fe₂O₃ in an amount of 0.3% by mass or more and 1.0% by mass or less and FeO in an amount of 0.05% by mass or more and 0.5% by mass or less, having ultraviolet transmittance at a wavelength of 350 nm of 1.5% or less, and having a minimum value of transmittance in a region of from 550 nm to 1,700 nm.

The thickness of the glass substrates 2 and 3 is not always limited. However, the thickness thereof is preferably 1 mm or more and 4 mm or less, and more preferably 1.8 mm or more and 2.5 mm or less. Coating for giving water-repellent function, hydrophilic function, antifogging function and the like may be applied to the glass substrates 2 and 3. When the glass substrate is a UV green glass plate, its thickness is preferably 1 mm or more and 4 mm or less, and more preferably 1.8 mm or more and 2.5 mm or less.

The laminated glass 1 of the present invention can be produced by overlaying the glass substrate 2, the adhesive sheet 5, the composite film 4, the adhesive sheet 6 and the glass substrate 3 in this order, conducting a preliminary compression bonding process, and then conducting a main compression bonding process. In this case, the laminated glass 1 may be produced by previously overlaying only the adhesive sheet 5, the composite film 4 and the adhesive sheet 6 to form an intermediate body, overlaying the glass substrates 2 and 3 on both main surfaces of the intermediate body, and then conducting a preliminary bonding process and a main bonding process.

The preliminary compression bonding process has an object of deaeration between constituent members, and can be conducted by, for example, placing a laminate of the glass substrates 2 and 3, the composite film 4 and the adhesive sheets 5 and 6 in a vacuum bag such as a rubber bag connected to an exhaust system, and holding the laminate therein at a temperature of 70° C. or higher and 130° C. or lower for 10 minutes or more and 90 minutes or less while conducting deaeration such that the inner pressure is 100 kPa or less, and preferably from about 1 to 36 kPa.

In the case where the holding temperature is lower than 70° C., the preliminary compression bonding may not be sufficient. On the other hand, in the case where the holding temperature exceeds 130° C., heat shrinkage of the composite film 4 excessively proceeds, and cracks may be generated. This is not preferred. From the standpoint that the preliminary compression bonding process is effectively conducted, the holding temperature is preferably 90° C. or higher, and more preferably 110° C. or higher.

In the case where the holding time is less than 10 minutes, the preliminary compression bonding may not be sufficient. On the other hand, in the case where the holding time exceeds 90 minutes, not only the productivity is decreased, but heat shrinkage of the composite film 4 excessively proceeds, and cracks may be generated. This is not preferred. The holding time is preferably 20 minutes or more and 60 minutes or less from the standpoint of conducting the preliminary compression bonding further effectively and efficiently.

The main compression bonding process is conducted to sufficiently bond the glass substrates 2, 3 and the composite film 4 by the adhesive sheets 5 and 6, and can be conducted by, for example, placing a preliminary compression bonded body obtained by the preliminary compression bonding process in a autoclave, and holding at a temperature of 120° C. or higher and 150° C. or lower under a pressure of 0.98 MPa or more and 1.47 MPa or less.

The laminated glass 1 of the present invention can preferably be used in vehicles such as automobiles, railways and ships, and can particularly preferably be used in windshield and the like of automobiles. The laminated glass 1 of the present invention is preferably that total solar transmittance (Tts) defined by ISO 13837 (2008) is 60% or less, and visible light transmittance (Tv) is 80% or more. In particular, when the near infrared absorbing film 43 is provided in the composite film 4, an adhesive sheet containing infrared shielding fine particles is used as the adhesive layer 5 on the light exit side, and a UV green glass plate is used as the glass substrate 2 at the same side, the total solar transmittance (Tts) can be 50% or less, and the visible light transmittance (Tv) can be 75% or more, whereby such a laminated glass can preferably be used in various vehicles including automobiles.

### EXAMPLES

The present invention is described in more detail below by reference to Examples.

### Example 1

Prior to the production of a laminated glass, a composite film comprising a resin film having on both main surfaces thereof an infrared reflective film and a near infrared absorbing film, respectively, was produced.

PET film only one surface of which having been subjected to an easy adhesion treatment (manufactured by Toyobo Co., Ltd., trade name: COSMOSHINE A4100, thickness: 50 μm) was provided as a resin film. The PET film was introduced in a vacuum chamber, Nb₂O₅ layer constituting a high refractive index layer and SiO₂ layer constituting a low refractive index layer were alternately overlaid on the main surface not having been subjected to an easy adhesion treatment by a magnetron sputtering method to laminate nine layers. Thus, an infrared reflective layer was formed.

Each Nb₂O₅ layer was formed by conducting pulse sputtering of a frequency of 20 kHz, a power density of 5.1 W/cm² and a reverse pulse width of 5 μsec under a pressure of 0.1 Pa using NBO target (manufactured by AGC Ceramics, trade name: NBO) while introducing a mixed gas obtained by mixing 5 vol % of oxygen gas with argon gas.

Each SiO₂ layer was formed by conducting pulse sputtering of a frequency of 20 kHz, a power density of 3.8 W/cm² and a reverse pulse width of 5 μec under a pressure of 0.3 Pa using Si target while introducing a mixed gas obtained by mixing 27 vol % of oxygen gas with argon gas.

The thickness of each of the Nb₂O₅ layer and the SiO₂ layer was adjusted by changing a film formation time, and was Nb₂O₅ layer (95 nm)/SiO₂ layer (153 nm)/Nb₂O₅ layer (95 nm)/SiO₂ layer (153 nm)/Nb₂O₅ layer (95 nm)/SiO₂ layer (153 nm)/Nb₂O₅ layer (95 nm)/SiO₂ layer (250 nm)/Nb₂O₅ layer (100 nm) in the order from the PET film side.

Separately, 0.1527 g of a diimmonium dye (manufactured by Nippon Kayaku Co., Ltd., trade name: KAYASORB IRG-068) as a near infrared absorbing dye was dissolved and dispersed in a mixed solvent of methyl isobutyl ketone 11.66 g and toluene 3.0 g. Then, 9.89 g of acrylic resin (manufactured by Nippon Shokubai Co., Ltd., trade name: HALS HYBRID IR-G205, refractive index: 1.51, solid content: 30%) was dissolved in the resulting solution to prepare a coating liquid.

The coating liquid was applied to the easy adhesion treatment side (main surface side at which an infrared reflective film is not formed) of the resin film with a Meyer bar such that the thickness after drying is 4 μm, and the resulting coating was dried at 100° C. for 1 minute to form a near infrared absorbing film. Thus, a composite film having an infrared reflective film and a near infrared absorbing film formed on both main surfaces of the resin film, respectively was obtained.

A clear glass having a thickness of 2 mm, a non-infrared absorbing type PVB sheet having a thickness of 0.76 mm, the composite film obtained above, a non-infrared absorbing type PVB sheet having a thickness of 0.76 mm and a clear glass having a thickness of 2 mm were overlaid in the order from the light exit side to obtain a laminate. The composite film was arranged such that the near infrared absorbing film side is a light exit side.

The laminate was placed in a vacuum bag, and heated at 120° C. for 30 minutes such that the inner pressure is about 100 kPa or less to obtain a preliminary compression bonded body. The preliminary compression bonded body was placed in an autoclave, and heated at a temperature of 135° C. under a pressure of 1.3 MPa for 60 minutes. Thus, a laminated glass was obtained.

### Example 2

A laminated glass was produced in the same manner as in Example 1, except that in the production of the laminated glass of Example 1, the composite film was changed to a composite film in which a near infrared absorbing film is not formed, and the non-infrared absorption type PVB sheet provided on the light exit side was changed to an infrared absorption type PVB sheet.

The composite film in which a near infrared absorbing film is not formed was that the infrared reflective film was formed on the resin film in the same manner as in Example 1 but a near infrared absorbing film was not formed, and the composite film was provided such that the infrared reflective film side is the light incident side. The infrared absorption type PVB sheet used was trade name: ELEX•CLEAR FILM, manufactured by Sekisui Chemical Co., Ltd. (PVB sheet containing 0.2 mass % of ITO fine particles as infrared shielding fine particles).

### Example 3

A laminated glass was produced in the same manner as in Example 1, except that in the production of the laminated glass of Example 2, the infrared absorption type PVB sheet arranged at the light exit side was changed to a non-infrared absorption type PVB sheet, and the clear glass arranged at the same side was changed to a UV green glass. The UV green glass used was trade name: UV verre, manufactured by AGC (Tts:62.6%, Tv:82.4%).

### Example 4

A laminated glass was produced in the same manner as in Example 1, except that in the production of the laminated glass of Example 1, the non-infrared absorption type PVB sheet arranged at the light exit side was changed to an infrared absorption type PVB sheet, and the clear glass arranged at the same side was changed to a UV green glass.

### Comparative Example 1

A clear glass, an infrared absorption type PVB sheet and a clear glass in the order from a light exit side were overlaid to form a laminate, and using the laminate, a laminated glass was produced in the same manner as in Example 1.

### Comparative Example 2

A UV green glass, an infrared absorption type PVB sheet and a clear glass in the order from a light exit side were overlaid to form a laminate, and using the laminate, a laminated glass was produced in the same manner as in Example 1.

### Comparative Example 3

A clear glass, a non-infrared absorption type PVB sheet, a composite film having formed thereon only a near infrared absorbing film, a non-infrared absorption type PVB sheet, and a clear glass in the order from a light exit side were overlaid to form a laminate, and using the laminate, a laminated glass was produced in the same manner as in Example 1. The composite film in which only a near infrared absorbing film is formed was that an infrared reflective film was not formed and only a near infrared absorbing film is formed in the same manner as in Example 1, and was provided such that the near infrared absorbing film side is the light exit side.

### Comparative Example 4

A clear glass, a non-infrared absorption type PVB sheet, a composite film having formed thereon only an infrared reflective film, a non-infrared absorption type PVB sheet, and a clear glass in the order from a light exit side were overlaid to form a laminate, and using the laminate, a laminated glass was produced in the same manner as in Example 1.

### Comparative Example 5

A clear glass, a non-infrared absorption type PVB sheet, a composite film having formed thereon only an infrared reflective film, an infrared absorption type PVB sheet, and a clear glass in the order from a light exit side were overlaid to form a laminate, and using the laminate, a laminated glass was produced in the same manner as in Example 1.

### Comparative Example 6

A clear glass, a non-infrared absorption type PVB sheet, a composite film having formed thereon only an infrared reflective film, a non-infrared absorption type PVB sheet, and a UV green glass in the order from a light exit side were overlaid to form a laminate, and using the laminate, a laminated glass was produced in the same manner as in Example 1.

Each member used in the laminated glasses of Comparative Examples was basically the same as the member used in Examples.

The laminated glasses of the Examples and the Comparative Examples were subjected to spectrometric measurement using SolidSpec-3700 (trade name) manufactured by Shimadzu Corporation, and total solar transmittance (Tts) and A-light source visible light transmittance (Tv, A-light source) were calculated according to ISO 13837 (2008). Calculation results are shown in Table 1 together with the configurations of laminated glasses.

In Table 1, “CG” means a clear glass, “UVGG” means a UV green glass, “PVB” means a non-infrared absorption type PVB sheet, and “PVB (absorption)” means an infrared absorption type PVB sheet. Furthermore, “reflective film” means an infrared reflective film, “absorbing film” means a near infrared absorbing film, a composite film having an indication of any of “reflective film” or “absorbing film” means that the film is formed on the resin film, and a composite film having no indication of “reflective film” and “absorbing film” means that the film is not formed and the resin film is not provided.

TABLE 1

| | Example | | | | Comparative Example | | | | | |
|---|---|---|---|---|---|---|---|---|---|---|
| | 1 | 2 | 3 | 4 | 1 | 2 | 3 | 4 | 5 | 6 |
| Glass on vehicle | CG | CG | CG | CG | CG | CG | CG | CG | CG | UVGG |
| exterior side | | | | | | | | | | |
| (Light incident | | | | | | | | | | |
| side) | | | | | | | | | | |
| PVB type | PVB | PVB | PVB | PVB | PVB | PVB | PVB | PVB | PVB | PVB |
| (Adhesive sheet) | | | | | (Absorption) | (Absorption) | | | (Absorption) | |
| Film | Reflective | Reflective | Reflective | Reflective | — | — | — | Reflective | Reflective | Reflective |
| (Composite film) | film | film | film | film | | | | film | film | film |
| | Absorbing | — | — | Absorbing | — | — | Absorbing | — | — | — |
| | film | | | film | | | film | | | |
| PVB type | PVB | PVB | PVB | PVB | — | — | PVB | PVB | PVB | PVB |
| (Adhesive sheet) | | (Absorption) | | (Absorption) | | | | | | |
| Glass on vehicle | CG | CG | UVGG | UVGG | CG | UVGG | CG | CG | CG | CG |
| interior side | | | | | | | | | | |
| (Light exit glass) | | | | | | | | | | |
| Tts (%) | 56.3 | 55.2 | 53.0 | 45.6 | 72.9 | 63.3 | 71.3 | 63.4 | 59.3 | 58.4 |
| Tv (%) | 86.8 | 87.3 | 81.1 | 76.9 | 86.2 | 78.2 | 84.2 | 86.9 | 85.6 | 77.8 |

As is apparent from Table 1, it is seen that when a near infrared absorbing film together with an infrared reflective film are provided on a resin film (Example 1), the total solar transmittance (Tts) can be 60% or less, particularly 57% or less, and the visible light transmittance (Tv) can be 80% or more. Similarly, even in the case that only an infrared reflective film is provided on the resin film, when an infrared absorption type PVB sheet is provided at a light exit side (Example 2) or a UV green glass is used (Example 3), the total solar transmittance (Tts) can be 60% or less, particularly 57% or less, and the visible light transmittance (Tv) can be 80% or more.

Particularly, when a near infrared absorbing film is provided on a resin film and an infrared absorption type PVB sheet and a UV green glass are used at a light exit side (Example 4), the total solar transmittance (Tts) can be 50% or less, particularly 48% or less, while securing 75% or more of visible light transmittance (Tv). The laminated glasses of Examples 1 to 4 can be durable to practical use as automobile applications.

Although the present invention has been described in detail and by reference to the specific embodiments, it is apparent to one skilled in the art that various modifications or changes can be made without departing the spirit and scope of the present invention.

This application is based on Japanese Patent Application No. 2009-285548 filed on Dec. 16, 2009, the disclosure of which is incorporated herein by reference.

### INDUSTRIAL APPLICABILITY

According to the present invention, in a laminated glass in which a composite film having an infrared reflective film comprising a high refractive index layer and a low refractive index layer, formed on a light-incident-side main surface of a resin film, is bonded between a pair of glass substrates by a pair of adhesive sheets, (1) the composite film has a near infrared absorbing film comprising a transparent resin having near infrared absorbing dye dispersed therein, on a light exit side main surface of the resin film, (2) of the pair of the adhesive sheets, the adhesive sheet on the light exit side with respect to the composite film contains infrared shielding fine particles, or (3) of the pair of glass substrates, the glass substrate on the light exit side with respect to the composite film is a UV green glass plate, whereby the total solar transmittance can be reduced as compared with the conventional laminated glass.

1. A laminated glass comprising:
a pair of glass substrates facing with each other;
a composite film arranged between the pair of glass substrates and comprising a resin film and an infrared reflective film which comprises a high refractive index layer and a low refractive index layer and is formed on a light-incident-side main surface of the resin film; and
a pair of adhesive sheets arranged between the pair of glass substrates and the composite film to bond the pair of glass substrates and the composite film,
wherein the laminated glass has at least one of the following configurations (1) to (3):
(1) the composite film has a near infrared absorbing film comprising a transparent resin having a near infrared absorbing dye dispersed therein, on a light exit side main surface of the resin film;
(2) of the pair of adhesive sheets, the adhesive sheet on the light exit side with respect to the composite film contains infrared shielding fine particles; and
(3) of the pair of glass substrates, the glass substrate on the light exit side with respect to the composite film is a UV green glass plate.

2. The laminated glass according to claim 1, which has the configuration (1), wherein the near infrared absorbing dye contains a diimmonium dye.

3. The laminated glass according to claim 2, wherein the near infrared absorbing dye contains both the diimmonium dye and other near infrared absorbing dye, and the diimmonium dye is contained in an amount of 50% by mass or more based on a total amount of the diimmonium dye and the other near infrared absorbing dye.

4. The laminated glass according to claim 1, wherein the near infrared absorbing dye is contained in an amount of 0.1 parts by mass or more and 20 parts by mass or less, based on 100 parts by mass of the transparent resin.

5. The laminated glass according to claim 1, which has the configuration (1), wherein the near infrared absorbing film is a coating film obtained by coating a coating liquid comprising the transparent resin, the near infrared absorbing dye and a solvent on the resin film, followed by drying.

6. The laminated glass according to claim 1, which has the configuration (1), wherein the infrared reflective film is located closer to a light incident side than the near infrared absorbing film.

7. The laminated glass according to claim 1, which has the configuration (1), wherein the near infrared absorbing film has a thickness of 500 nm or more and 50 μm or less.

8. The laminated glass according to claim 1, which has the configuration (2), wherein the infrared shielding fine particles are indium oxide fine particles doped with tin (ITO fine particles).

9. The laminated glass according to claim 8, wherein the ITO fine particles have an average particles size of primary particles thereof of 100 nm or less.

10. The laminated glass according to claim 1, which has the configuration (2), wherein the infrared reflective film is located closer to a light incident side than the adhesive sheet containing the infrared shielding fine particles.

11. The laminated glass according to claim 1, wherein the adhesive sheet has a thickness of 0.1 mm or more and 1 mm or less.

12. The laminated glass according to claim 1, wherein the pair of glass substrates each has a thickness of 1 mm or more and 4 mm or less.

13. The laminated glass according to claim 1, having total solar transmittance (Tts) of 60% or less and visible light transmittance (Tv) of 80% or more.

14. The laminated glass according to claim 1, having total solar transmittance (Tts) of 50% or less and visible light transmittance (Tv) of 75% or more.

15. A vehicle having the laminated glass according to claim 1.
